(19) United States
(12) Patent Application Publication
(10) Pub. No.: US 2025/0274833 A1
(43) Pub. Date: Aug. 28, 2025

(54) METHOD FOR CELL RESELECTION AND USER EQUIPMENT

(71) Applicant: MEDIATEK INC., Hsinchu City (TW)

(72) Inventors: Wei-Jen CHEN, Hsinchu City (TW); Yuan YUAN, Beijing (CN); Wan-Ting HUANG, Hsinchu City (TW); Jun HU, Beijing (CN); Nien-En WU, Hsinchu City (TW); Kuan-Lin CHEN, Hsinchu City (TW)

(21) Appl. No.: 18/595,885

(22) Filed: Mar. 5, 2024

(30) Foreign Application Priority Data
Feb. 23, 2024 (CN) 202410204873.8

(51) Int. Cl. H04W 36/30; H04W 24/10

(52) U.S. Cl. CPC H04W 36/30; H04W 24/10

(57) ABSTRACT

A method for cell reselection is provided. The method includes using user equipment (UE) to determine a key performance indicator (KPI) according to the scenario that the UE is in. The method further includes the UE measuring the KPI of the source cell, which is the serving cell of the UE. The method further includes the UE estimating the KPI of a target cell according to at least one parameter of the target cell. The method further includes the UE determining to camp on the target cell according to the KPI of the source cell and the KPI of the target cell.

### CROSS REFERENCE TO RELATED APPLICATIONS

This application claims the benefit of China Application No. 202410204873.8, filed Feb. 23, 2024, the entirety of which is incorporated by reference herein.

### BACKGROUND OF THE INVENTION

### Field of the Invention

The present invention relates to wireless communication, and, in particular, to cell reselection based on an application scenario of the user equipment.

### Description of the Related Art

Cell reselection is a procedure allowing user equipment (UE) to change cells after the UE has camped on a cell. When the UE camps on a serving cell and is in an idle mode, the UE may measure the parameters and attributes of the serving cell and neighboring cells. Then, the UE may determine to reselect a target cell among the neighboring cells when the measurement results indicate that the target cell is better than the serving cell. However, the UE is used to refer the network configuration to select the cell. In other words, whether the UE can switch to another cell is restricted by the network configuration. For example, when the UE is served by a cell with weak signal strength, there could be another cell with good signal quality in the inter-frequency absolute radio-frequency number (ARFCN). However, reselection is blocked by the network configuration (e.g. due to the ARFCN priority). Furthermore, the network configuration may not be proper in every UE application scenario. An improper network configuration will prevent the UE from changing to a more suitable cell and thus degrade the performance of the UE and impact user experience.

A solution is sought to improve the cell reselection procedure.

### BRIEF SUMMARY OF THE INVENTION

An embodiment of the present invention provides a method for cell reselection. The method includes using user equipment (UE) to determine a key performance indicator (KPI) according to the scenario that the UE is in. The method further includes the UE measuring the KPI of the source cell, which is the serving cell of the UE. The method further includes the UE estimating the KPI of a target cell according to at least one parameter of the target cell. The method further includes the UE determining to camp on the target cell according to the KPI of the source cell and the KPI of the target cell.

An embodiment of the present invention provides a kind of user equipment (UE). The UE includes a processor and a memory. The memory is configured to store a program. The processor is configured to drive the program to execute tasks. The tasks include determining a key performance indicator (KPI) according to a scenario that the UE is in. The tasks further include measuring the KPI of a source cell, which is a serving cell of the UE. The tasks further include estimating the KPI of a target cell according to at least one parameter of the target cell. The tasks further include determining to camp on the target cell according to the KPI of the source cell and the KPI of the target cell.

### BRIEF DESCRIPTION OF THE DRAWINGS

The present invention can be more fully understood by reading the subsequent detailed description and examples with references made to the accompanying drawings, wherein:

FIG. 1 shows an illustrative diagram of a communication system according to the embodiments of the present disclosure;

FIG. 2 shows a block diagram of an electronic device according to the embodiments of the present disclosure;

FIG. 3 shows a flow diagram of a method according to the embodiments of the present disclosure; and

FIG. 4 shows a flow diagram of a method according to the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

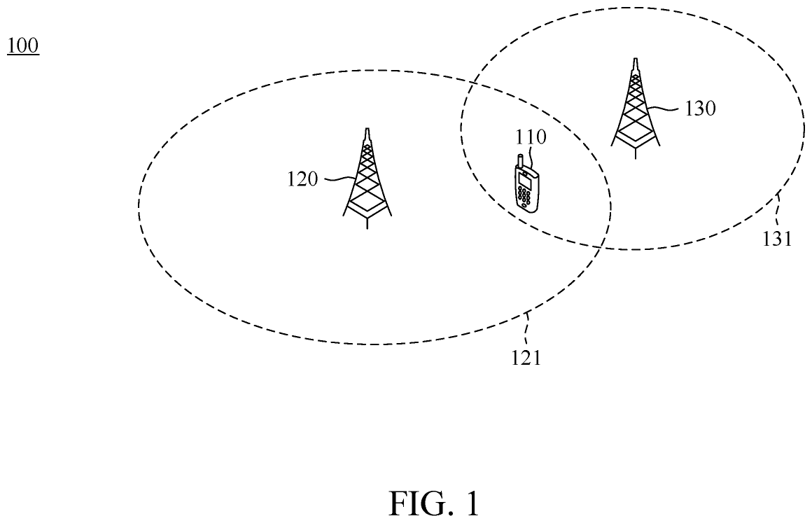

FIG. 1 shows an illustrative diagram of a communication system 100 according to the embodiments of the present disclosure. Communication system 100 includes a user equipment (UE) 110, a base station 120, and a base station 130. For example, the base station 120 and the base station 130 may be access points, access terminals, evolved Node-Bs (eNBs), or gNodeBs (gNBs). The base station 120 provides wireless communication to multiple UEs within a geographic area 121, and the base station 130 provides wireless communication to multiple UEs within a geographic area 131. In some embodiments, a cell is a geographic area served by a base station, such as the geographic areas 121 and 131 (also referred to as cells 121 and 131). In some embodiments, a cell is at least one channel served by a base station, and different cells may be served by the same or different base stations. Different cells may have different channel conditions, network configurations, and/or ARFCN priority.

In one example, the UE 110 camps on the cell 121, and the cell 121 is referred to as the serving cell or source cell of the UE 110. Thus, the UE 110 communicates with the base station 120. For example, the UE 110 may connect to a network (such as Internet) through the base station 120 or receive paging from the base station 120. When the UE 110 is in an idle mode (such as an RRC_IDLE mode), the UE 110 may measure the parameters and attributes of the cell 121 and the cell 131. The cell 131 is referred to as a target cell, a neighboring cell, or a candidate cell. Based on the measurement result, the UE 110 may determine to change/switch/handover to the cell 131 and camp on the cell 131.

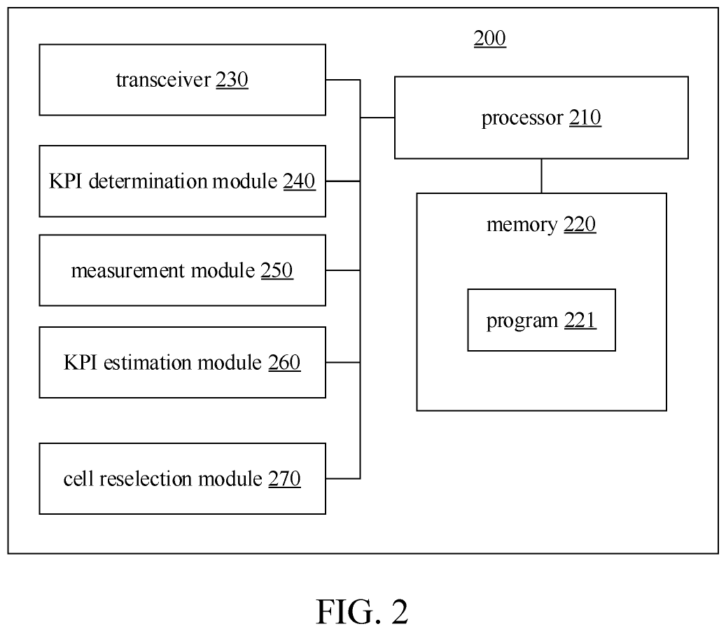

FIG. 2 shows a block diagram of an electronic device 200 according to the embodiments of the present disclosure. Electronic device 200 may perform various functions to implement processes and methods described herein, such as methods for cell reselection in accordance to embodiments of the present disclosure. Electronic device 200 may be a part of a user equipment (UE) or implemented in a user equipment (the electronic device 200 is also referred to as a UE 200 below). For example, UE 200 may be a mobile apparatus, a wearable apparatus, a wireless communication apparatus, or a computing apparatus. In some embodiments, UE 200 is implemented in a smartphone, a smartwatch, a tablet computer, a notebook computer, or a home control center. Electronic device may be implemented in the form of one or more integrated-circuit (IC) chips such as, one or more processors. The UE 200 includes a processor 210, a memory 220, a transceiver 230, a KPI determination module 240, a measurement module 250, a KPI estimation module 260, and a cell reselection module 270.

The processor 210 controls operations of the UE 200. The processor 210 provides the required process ability to perform operating systems, programs, software, modules, applications, and functions of the UE 200. In some embodiments, processor 210 may be implemented in the form of hardware with electronic components including transistors, diodes, capacitors, resistors, or inductors. These components are configured and arranged to achieve specific purposes in accordance with the present disclosure. In other words, the processor 210 is a special-purpose machine specifically configured to perform specific tasks including method of the present disclosure. For example, the processor 210 may be a general purpose micro-processor, a central processing unit, the combination of the general purpose processor and special purpose processor, and/or related chip set.

The memory 220 stores data required by the processor 210. The memory 220 may include non-volatile memories, such as read only memory (ROM) and flash memory. The memory 220 may also include volatile memories, such as dynamic random access memory (DRAM) and static random access memory (SRAM). In some embodiments, the memory 220 stores a program 221 (e.g. computer-readable instruction). The program 221 can be operated by the processor 210. When the program 221 is operated by the processor 210, the program 221 causes the processor 210 to implement methods according to the embodiments of the present disclosure.

The transceiver 230 is capable to transmit and receive data wirelessly. The transceiver 230 is coupled with one or more antennas (not shown). The transceiver 230 receives radio frequency (RF) signals from the antenna and converts RF signals to baseband signals. The transceiver 230 also converts the baseband signals to the RF signals and sends out the RF signals through the antenna.

The KPI determination module 240 is configured to determine a KPI according to the scenario that UE 200 is in. The measurement module 250 is configured to measure the KPI of the source cell, the parameters of the target cell, and the KPI of the target cell. The KPI estimation module 260 is configured to estimate the KPI of a target cell according to at least one parameter of the target cell. The cell reselection module 270 is configured to determine to camp on the source cell or the target cell according to the KPI of the source cell and the KPI of the target cell. In some embodiments, the KPI determination module 240, the measurement module 250, the KPI estimation module 260, and the cell reselection module 270 are software modules implemented by the processor 210. For example, the processor 210 is configured to drive program 221 and implement these modules in order to execute methods of the present disclosure. In other embodiments, the KPI determination module 240, the measurement module 250, the KPI estimation module 260, and the cell reselection module 270 are hardware circuits which are similar to processor 210. Thus, the KPI determination module 240, the measurement module 250, the KPI estimation module 260, and the cell reselection module 270 may be referred to as the KPI determination circuit, the measurement circuit, the KPI estimation circuit, and the cell reselection circuit, respectively. For example, the KPI determination module 240, the measurement module 250, the KPI estimation module 260, and the cell reselection module 270 are chips, integrated circuits, or microprocessors.

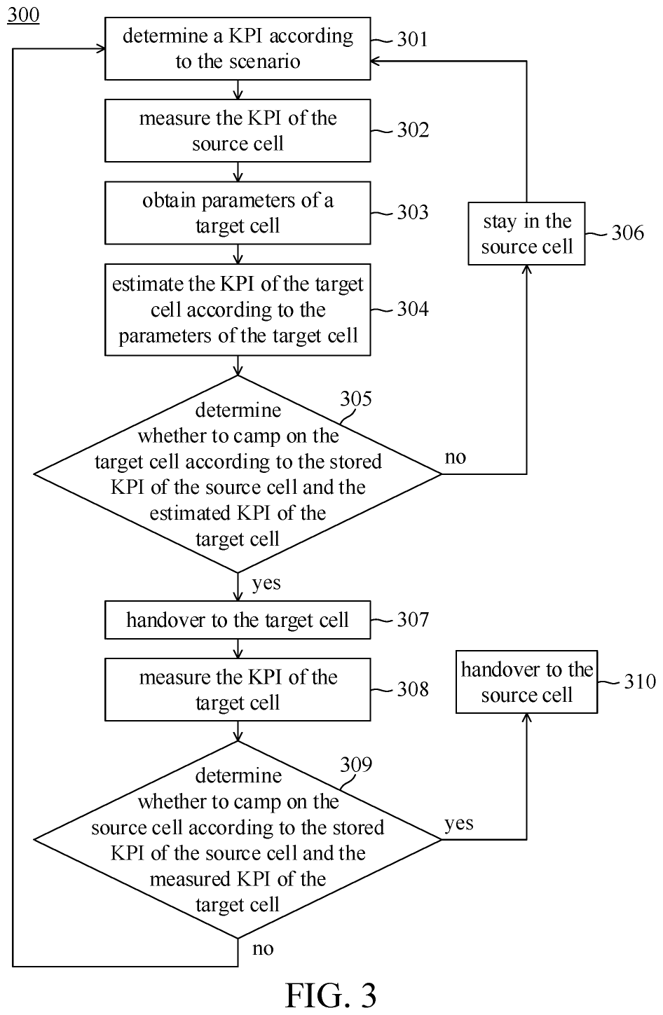

FIG. 3 shows a flow diagram of a method 300 according to the embodiments of the present disclosure. The method 300 can be performed by the UE 200. The method 300 starts from operation 301. In operation 301, the KPI determination module 240 determines a KPI according to a scenario that the UE 200 is in. Specifically, the scenario includes but not limit to whether the UE is in idle or standby mode, whether the UE is transmitting data, whether the UE is executing delay-sensitive applications, etc. The KPI determination module 240 may determine the scenario according to the operation that the UE 200 is performing. For example, the KPI determination module 240 may determine the scenario according to the mode that the UE 200 is operated in (such as idle/stand-by mode or connected mode), the application/function that the UE 200 is performing, and data that the UE 200 is transmitting or receiving. In some embodiments, the KPI determination module 240 determines the scenario according to types (such as voice and video) and sizes of data that the UE 200 is transmitting or receiving.

Then, the KPI determination module 240 can determine the KPI according to the scenario. When the UE 200 is in an idle mode or a stand-by mode, the KPI determination module 240 determines that the KPI is power consumption. When the UE 200 is in an idle mode or a stand-by mode, UE stand-by time is critical to user experience. It is desirable to extend the UE stand-by time as much as possible, and the less power consumption means that the UE has longer UE stand-by time. In some embodiments, the KPI determination module 240 determines that the KPI is a paging reception successful rate when the UE 200 is in an idle mode or a stand-by mode. On the other hand, when the UE is transmitting data, the KPI determination module 240 determines that the KPI is a data rate. When the UE is transmitting data, especially large files, user experience is affected by throughput and data transferring time, and the throughput and the data transferring time correspond to the data rate. Larger data rate leads to higher throughput and shorter data transferring time. In some embodiments, the KPI determination module 240 determines the KPI is data rate when the UE 200 is transmitting a data having a size larger than a threshold. Moreover, when the UE is performing a delay-sensitive application, the KPI determination module 240 determines that the KPI is latency. For example, the delay-sensitive application is playing online game or watching live stream. When the UE is performing the delay-sensitive application, it is desirable to have smooth interaction without stuck. As a result, shorter latency leads to better user experience.

In operation 302, the measurement module 250 measures the determined KPI of the source cell. The source cell is the serving cell of the UE 200. The measured KPI is then stored in the memory 220. Because the UE 200 camps on the source cell, the KPI of source cell can be measured directly. In operation 303, the UE 200 obtains parameters of a target cell other than the source cell. These parameters are parameters which affect the determined KPI. In some embodiments, the UE 200 measures these parameters (e.g. using measurement module 250 or other circuits). In some embodiments, the UE 200 obtains these parameters from the information (such as broadcast messages) received from the base station of the target cell. In operation 304, the KPI estimation module 260 estimates the KPI of the target cell according to the parameters of the target cell.

When the UE 200 is in an idle mode or a stand-by mode, the parameters obtained in operation 303 include signal quality, paging cycle, or both. In some embodiments, signal quality parameters include reference signal received power (RSRP), received signal strength indicator (RSSI), reference signal received quality (RSRQ), and/or signal to interference plus noise ratio (SINR). The UE needs to operate more process to ensure link reliability when the signal quality is poor. Thus, the higher the signal quality is, the lower the estimated power consumption of target cell is. Moreover, the UE can stay in sleep mode for a longer time and save more power when the paging cycle is long. Thus, the longer the paging cycle is, the lower the estimated power consumption of target cell is.

When the UE is transmitting data, the parameters obtained in operation 303 include signal quality, rank, bandwidth (BW), allocated resource block (such as the size and number of the allocated resource block), and/or allocated component carrier (CC) number (number of carrier aggregation (CA)). In some embodiments, signal quality parameters include a RSRP, RSSI, and/or RSRQ. In this disclosure, rank may refer to the number of independent data streams simultaneously transmitted/received in a multiple-input-multiple-output (MIMO) transmission. The data rate becomes larger when the signal quality is good and when there's more available resource. Thus, the estimated data rate of target cell is larger when the signal quality is higher, the rank is higher, bandwidth is larger, allocated resource block is more or larger, and/or allocated component carrier number is larger.

When the UE is performing a delay-sensitive application, the parameters obtained in operation 303 include signal quality, subcarrier spacing (SCS), and/or symbol duration. In some embodiments, signal quality parameters include a RSRP, RSSI, and/or RSRQ. The probability of re-transmission becomes lower when the signal quality is good. Thus, the higher the signal quality is, the shorter the estimated latency of target cell is. Moreover, the shorter the symbol duration is, the shorter the estimated latency of target cell is. Similarly, the larger the subcarrier spacing is, the shorter the estimated latency of target cell is.

In some embodiments, the KPI estimation module 260 may stores the correspondence relationships between parameters and the corresponding KPI of the parameters. The correspondence relationships may be obtained from statistics, simulations, or experiments. In other embodiments, the KPI estimation module 260 may use algorithms or mathematical formulas to estimate the KPI according to the parameters.

In operation 305, the cell reselection module 270 determines whether to camp on the target cell according to the stored KPI of the source cell and the estimated KPI of the target cell. If no, the method 300 proceeds to operation 306. If yes, the method 300 proceeds to operation 307. The cell reselection module 270 determines whether the KPI of the source cell is better than the KPI of the target cell and decides to camp on the cell with better KPI. When the UE 200 is in an idle mode or a stand-by mode, the cell reselection module 270 determines to camp on the cell with lower power consumption. When the UE 200 is transmitting data, the cell reselection module 270 determines to camp on the cell with higher data rate. When the UE 200 is performing a delay-sensitive application, the cell reselection module 270 determines to camp on the cell with shorter latency.

In operation 306, the UE 200 stays in the source cell. Then, the method 300 goes back to operation 301. In operation 307, the UE 200 handovers to the target cell. In some embodiments, the UE 200 transmits a message indicating the preference to handover to the target cell to the base station of the source cell then performs the handover procedure. Thus, the UE 200 camps on the target cell after operation 307.

In operation 308, the measurement module 250 measures the determined KPI of the target cell. Because the UE 200 camps on the target cell now, the KPI of the target cell can be measured directly. As mentioned above, when the UE 200 is in an idle mode or a stand-by mode, the measurement module 250 measures the power consumption of the target cell. When the UE 200 is transmitting data, the measurement module 250 measures the data rate of the target cell. When the UE 200 is performing a delay-sensitive application, the measurement module 250 measures the latency of the target cell.

In operation 309, the cell reselection module 270 determines whether to camp on the source cell according to the stored KPI of the source cell and the measured KPI of the target cell. If yes, the method 300 proceeds to operation 310. If no, the method 300 goes back to operation 301. Operation 309 is similar to operation 305. As mentioned above, the cell reselection module 270 determines whether the stored KPI of the source cell is better than the measured KPI of the target cell and decides to camp on the cell with better KPI. In operation 310, the UE 200 handovers to the source cell. That is, if the measured KPI of the target cell is worse than the stored KPI of the source cell, the UE 200 moves back to the original cell.

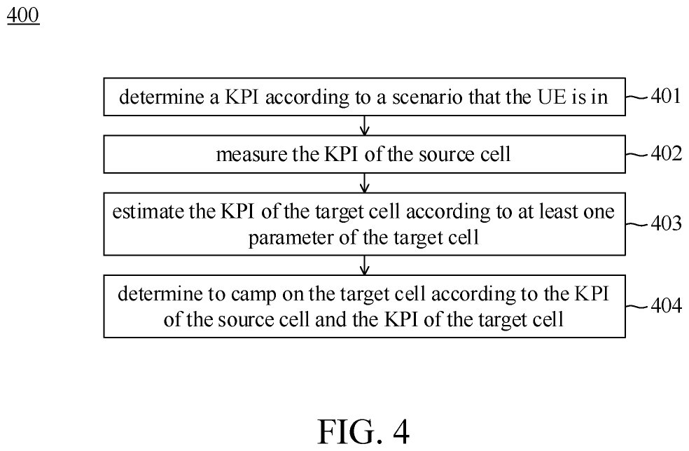

FIG. 4 shows a flow diagram of a method 400 according to the embodiments of the present disclosure. The method 400 can be performed by the UE 200. The method 400 starts from operation 401. In operation 401, the KPI determination module 240 determines a KPI according to a scenario that the UE 200 is in. In operation 402, the measurement module 250 measures the KPI of the source cell. The source cell is the serving cell of the UE 200. In operation 403, the KPI estimation module 260 estimates the KPI of a target cell according to at least one parameter of the target cell. In operation 404, the cell reselection module 270 determines to camp on the target cell according to the KPI of the source cell and the KPI of the target cell.

Thus, the proposed method can use different KPI as cell reselection metric under different scenarios so as to optimize user experience. Moreover, in the proposed embodiments, the UE can determine whether to leave the serving cell on its own. In other words, the UE can switch to another cell without limitation of the network configuration. As a result, the UE can find a proper cell which is most suitable to the current application scenario of the UE.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for cell reselection, comprising:
determining, by a user equipment (UE), a key performance indicator (KPI) according to a scenario that the UE is in;
measuring, by the UE, the KPI of a source cell, which is a serving cell of the UE;
estimating, by the UE, the KPI of a target cell according to at least one parameter of the target cell; and
determining, by the UE, to camp on the target cell according to the KPI of the source cell and the KPI of the target cell.

2. The method as claimed in claim 1, wherein determining the KPI according to the scenario which the UE is in comprises:
determining that the KPI is power consumption when the UE is in an idle mode or a stand-by mode.

3. The method as claimed in claim 2, wherein determining to camp on the target cell according to the KPI of the source cell and the KPI of the target cell comprises:
determining to camp on the target cell in response to a determination that the power consumption of the target cell is less than the power consumption of the source cell.

4. The method as claimed in claim 2, wherein the parameter comprises signal quality, paging cycle, or both.

5. The method as claimed in claim 1, wherein determining the KPI according to the scenario which the UE is in comprises:
determining the KPI is data rate when the UE is transmitting data.

6. The method as claimed in claim 5, wherein determining to camp on the target cell according to the KPI of the source cell and the KPI of the target cell comprises:
determining to camp on the target cell in response to the determination that the data rate of the target cell is higher than the data rate of the source cell.

7. The method as claimed in claim 5, wherein the parameter comprises signal quality, rank, bandwidth (BW), allocated resource block, and/or allocated component carrier number.

8. The method as claimed in claim 1, wherein determining the KPI according to the scenario which the UE is in comprises:
determining the KPI is latency when the UE is performing a delay-sensitive application.

9. The method as claimed in claim 8, wherein determining to camp on the target cell according to the KPI of the source cell and the KPI of the target cell comprises:
determining to camp on the target cell in response to the determination that the latency of the target cell is shorter than the latency of the source cell.

10. The method as claimed in claim 8, wherein the parameter comprises signal quality, subcarrier spacing (SCS), and/or symbol duration.

11. The method as claimed in claim 1, further comprising:
measuring, by the UE, the KPI of the target cell after camping on the target cell; and
determining, by the UE, whether to camp on the source cell according to the KPI of the source cell and the measured KPI of the target cell.

12. A user equipment (UE), comprising:
a processor; and
a memory, configured to store a program, wherein the processor is configured to drive the program to execute the following tasks:
determining a key performance indicator (KPI) according to a scenario that the UE is in;
measuring the KPI of a source cell, which is a serving cell of the UE;
estimating the KPI of a target cell according to at least one parameter of the target cell; and
determining to camp on the target cell according to the KPI of the source cell and the KPI of the target cell.

13. The UE as claimed in claim 12, wherein processor is further configured to:
determine that the KPI is power consumption when the UE is in an idle mode or a stand-by mode; and
determine to camp on the target cell in response to the determination that the power consumption of the target cell is less than the power consumption of the source cell.

14. The UE as claimed in claim 13, wherein the parameter comprises signal quality, paging cycle, or both.

15. The UE as claimed in claim 12, wherein the processor is further configured to:
determine the KPI is data rate when the UE is transmitting data; and
determine to camp on the target cell in response to the determination that the data rate of the target cell is higher than the data rate of the source cell.

16. The UE as claimed in claim 15, wherein the parameter comprises signal quality, rank, bandwidth (BW), allocated resource block, and/or allocated component carrier number.

17. The UE as claimed in claim 12, wherein the processor is further configured to:
determine the KPI is latency when the UE is performing a delay-sensitive application; and
determine to camp on the target cell in response to the determination that the latency of the target cell is shorter than the latency of the source cell.

18. The UE as claimed in claim 17, wherein the parameter comprises signal quality, subcarrier spacing (SCS), and/or symbol duration.

19. The UE as claimed in claim 12, wherein the processor is further configured to:
measure the KPI of the target cell after camping on the target cell;
determine whether to camp on the source cell according to the KPI of the source cell and the measured KPI of the target cell.
